(19) United States
(12) Patent Application Publication
(10) Pub. No.: US 2024/0179281 A1
(43) Pub. Date: May 30, 2024

(54) METHOD OF OUTPUTTING PATTERN IMAGE, PROJECTOR, AND NON-TRANSITORY COMPUTER-READABLE STORAGE MEDIUM STORING PROGRAM

(71) Applicant: SEIKO EPSON CORPORATION, Tokyo (JP)

(72) Inventors: Shiki FURUI, Matsumoto-shi (JP); Takumi OIKE, Matsumoto-shi (JP)

(21) Appl. No.: 18/498,250

(22) Filed: Oct. 31, 2023

(30) Foreign Application Priority Data
Oct. 31, 2022 (JP) 2022-174459

(51) Int. Cl. H04N 9/31

(52) U.S. Cl. CPC H04N 9/3185; H04N 9/3182

(57) ABSTRACT

A method of outputting a pattern image includes outputting a first pattern image which is used in a phase shift method, and which includes a first luminance distribution based on a first period, and a second luminance distribution based on a second period.

The present application is based on, and claims priority from JP Application Serial Number 2022-174459, filed Oct. 31, 2022, the disclosure of which is hereby incorporated by reference herein in its entirety.

### BACKGROUND

### 1. Technical Field

The present disclosure relates to a method of outputting a pattern image, a projector, and a non-transitory computer-readable storage medium storing a program.

### 2. Related Art

In the past, there has been used a technology of making, for example, a projection image projected on a projection surface and a taken image obtained by taking the projection image correspond to each other by image processing using a phase shift method.

In the technology related to JP-A-2010-271580, an illumination control device first makes a projection device project a striped pattern in which luminance changes periodically in a first direction into a projection area. Further, the illumination control device obtains the taken image from a camera which has taken the projection image. The illumination control device makes the projection image and the taken image correspond to each other in the first direction using the phase shift method. Then, the illumination control device makes the projection device project a striped pattern in which the luminance changes periodically in a second direction perpendicular to the first direction into the projection area. Similarly, the illumination control device obtains the taken image from the camera which has taken the projection image. The illumination control device makes the projection image and the taken image correspond to each other in the second direction using the phase shift method.

However, in Document 1, when using patterns different in phase from each other, it is necessary to execute the phase shift method as much times as the number of the patterns. As a result, since an execution time for executing the phase shift method increases, the convenience degrades.

### SUMMARY

A method of outputting a pattern image according to an aspect of the present disclosure includes outputting a first pattern image which is used in a phase shift method, and which includes a first luminance distribution based on a first period, and a second luminance distribution based on a second period.

Further, a projector according to an aspect of the present disclosure includes an optical device, and at least one processor, wherein the at least one processor controls the optical device to thereby output a first pattern image which is used in a phase shift method, and which includes a first luminance distribution based on a first period, and a second luminance distribution based on a second period.

Further, a non-transitory computer-readable storage medium storing a program according to an aspect of the present disclosure, the program making a computer execute processing including outputting a first pattern image which is used in a phase shift method, and which includes a first luminance distribution based on a first period, and a second luminance distribution based on a second period.

### BRIEF DESCRIPTION OF THE DRAWINGS

FIG. 1 is a block diagram showing a configuration of a projector 10 according to a first embodiment.

FIG. 2 is a flowchart showing an operation of the projector 10.

FIG. 3A through FIG. 3I are diagrams showing an example of pattern images.

FIG. 4A through FIG. 4E are diagrams showing an example of the pattern images.

FIG. 5A through FIG. 5E are diagrams showing an example of the pattern images.

FIG. 6A through FIG. 6E are diagrams showing an example of the pattern images.

FIG. 7A through FIG. 7G are diagrams showing an example of the pattern images.

### DESCRIPTION OF EMBODIMENTS

A method of outputting a pattern image, a projector, and a program according to the embodiment will hereinafter be described with reference to the drawings. It should be noted that in each of the drawings, the size and the scale of each of the constituents are arbitrarily made different from actual ones. Further, although the embodiment described below is a preferable specific example, and is therefore provided with a variety of technically preferable limitations, the scope of the present disclosure is not limited to these aspects unless the description to limit the present disclosure is particularly presented in the following description.

### 1: First Embodiment

### 1-1: Configuration of Embodiment

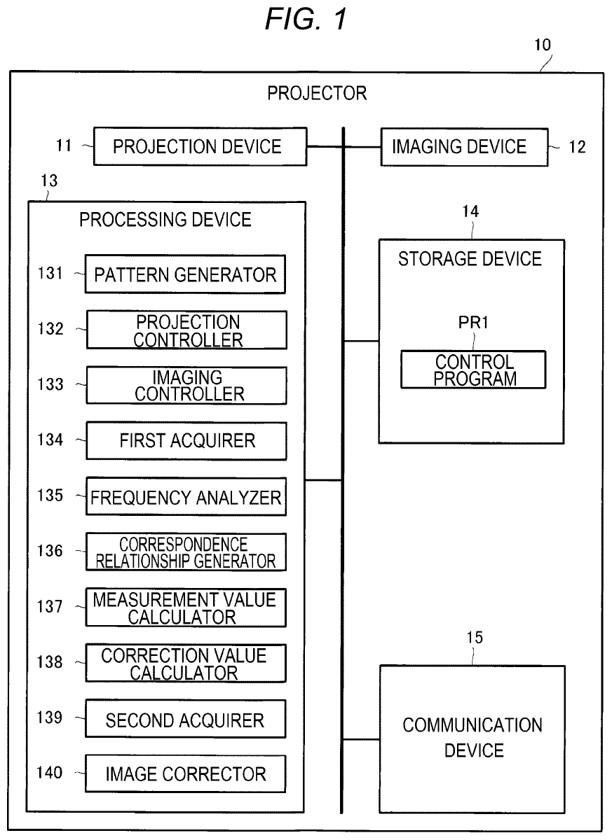

FIG. 1 is a block diagram showing a configuration of a projector 10 according to a first embodiment. The configuration of the projector 10 will hereinafter be described with reference to FIG. 1.

The projector 10 is provided with a projection device 11, an imaging device 12, a processing device 13, a storage device 14, and a communication device 15. The constituents of the projector 10 are coupled to each other with a single bus or a plurality of buses for communicating information. Further, the constituents of the projector 10 are each constituted by a single apparatus or a plurality of apparatuses, and some of the constituents of the projector 10 can be omitted.

The projection device 11 is a device for projecting a projection image on a projection surface such as a screen or a wall. The projection device 11 includes, for example, a light source, a liquid crystal panel, and a projection lens, modulates light from the light source using the liquid crystal panel, and projects the light thus modulated on the projection surface such as the screen or the wall via the projection lens. In particular in the present embodiment, the projection device 11 projects a pattern image generated by a pattern generator 131 described later on the projection surface. The projection device 11 is an example of an “optical device.” It should be noted that in the above description, as the liquid crystal panel, it is possible to use a transmissive liquid crystal light valve, or it is also possible to use a reflective liquid crystal light valve. Further, it is possible to use a digital mirror device or the like for controlling the emission direction of the incident light for every micromirror as a pixel to thereby modulate the light emitted from the light source. Further, the configuration provided with the plurality of light modulation devices for the respective colored light beams is not a limitation, and it is also possible to adopt a configuration of modulating the plurality of colored light beams with a single light modulation device in a time-sharing manner.

The imaging device 12 takes a display image which is projected on the projection surface by the projection device 11 to thereby be displayed. Further, the imaging device 12 outputs the taken image thus taken to the processing device 13. In particular in the present embodiment, the imaging device 12 takes the pattern image projected by the projection device 11 on the projection surface, and outputs the pattern image thus taken to the processing device 13. The imaging device 12 can be a regular digital camera, or can also be an image sensor.

The processing device 13 is a processor for controlling the whole of the projector 10, and is constituted by, for example, a single chip or a plurality of chips. The processing device 13 is formed of a central processing device (CPU: Central Processing Unit) including, for example, an interface with peripheral devices, an arithmetic device, and registers. It should be noted that some or all of the functions of the processing device 13 can also be realized by hardware such as a DSP (Digital Signal Processor), an ASIC (Application Specific Integrated Circuit), a PLD (Programmable Logic Device), or an FPGA (Field Programmable Gate Array). The processing device 13 executes a variety of types of processing in parallel or in sequence. The processing device 13 is an example of a “computer.”

The storage device 14 is a recording medium which can be read by the processing device 13, and stores a plurality of programs including a control program PR1 to be executed by the processing device 13. It should be noted that the control program PR1 can be transmitted from another device for managing the projector 10 via a communication network not shown. The storage device 14 can be formed of at least one of, for example, a ROM (Read Only Memory), an EPROM (Erasable Programmable ROM), an EEPROM (Electrically Erasable Programmable ROM), and a RAM (Random Access Memory). The storage device 14 can be called a register, a cache, a main memory, or a main storage device.

The communication device 15 is hardware as a transmitting/receiving device for performing communication with other devices. In particular in the present embodiment, the communication device 15 is also called, for example, a network device, a network controller, a network card, and a communication module.

The processing device 13 retrieves the control program PR1 from the storage device 14 and then executes the control program PR1 to thereby function as the pattern generator 131, a projection controller 132, an imaging controller 133, a first acquirer 134, a frequency analyzer 135, a correspondence relationship generator 136, a measurement value calculator 137, a correction value calculator 138, a second acquirer 139, and an image corrector 140.

The pattern generator 131 generates a pattern image to be used in the phase shift method. The details of the pattern image will hereinafter be described.

The number of times of performing the shift when executing the phase shift method according to the present embodiment is defined as N. Specifically, in the phase shift method according to the present embodiment, the projection device 11 sequentially projects the N pattern images. Further, the imaging device 12 takes the N pattern images sequentially projected. The processing device 13 performs the frequency analysis on a temporal change of the luminance in the N taken images to thereby obtain a plurality of phase values. Projecting the pattern image in the projection device 11 is an example of “outputting the pattern image.”

In the present specification, a coordinate

system on the liquid crystal panel provided to the projection device 11 is called a “panel coordinate system.” With respect to a coordinate (x, y) on the panel coordinate system, a plurality of arbitrary phase values changing continuously is defined as θ₁=g₁ (x, y), θ₂=g₂ (x, y), . . . , θᵣ=gᵣ (x, y). In this case, the amplitude of the projection pattern in the pattern image projected n-th (n=0, 1, . . . , N−1) is determined by Formula (1) described below.

f (x, y, n)=A₁cos (θ₁+2nn/N)+A₂cos (θ₂+4nn/N)+. . . +Aᵣcos (θᵣ+2rnn/N) Formula (1)

Here, A₁, A₂, . . . , Aᵣ are arbitrary constants for determining the luminance of images representing the luminance distributions corresponding to the respective trigonometric functions to be superimposed on the pattern image corresponding to Formula (1) described above. It should be noted that it is sufficient for the number of the pattern images thus taken, namely the shift count N, when defining the number of the trigonometric functions to be added in f (x, y, n) as r to be no smaller than N=2r+1. Specifically, when the imaging device 12 takes the pattern images no fewer than N=2r+1, it is possible to calculate the phase values θ₁, θ₂, . . . , θᵣ by the frequency analyzer 135 described later performing the discrete Fourier transform.

In other words, the pattern image generated by the pattern generator 131 includes a first luminance distribution based on a first period, and a second luminance distribution based on a second period. The pattern image is an example of a “first pattern image.” Further, as described above, the first pattern image is based on a function obtained by adding the plurality of trigonometric functions corresponding to the respective frequencies different from each other in the time direction.

Further, the pattern images no fewer than 2r+1 each have r luminance distributions, and at the same time, are different in luminance at the same coordinate of at least one luminance distribution corresponding to the same period out of the r luminance distributions.

The projection controller 132 makes the projection device 11 project the pattern image generated by the pattern generator 131 on the projection surface.

The imaging controller 133 makes the imaging device 12 take the pattern image projected on the projection surface.

The first acquirer 134 obtains the taken image, which is obtained by taking the pattern image, from the imaging device 12.

The frequency analyzer 135 performs the frequency analysis on the data representing the taken image obtained by the first acquirer 134.

In the present specification, the coordinate system in the taken image is referred to as a “camera coordinate system.” The frequency analyzer 135 performs the discrete Fourier transform on the temporal change in the luminance at the coordinate (X, Y) in the camera coordinate system of the N taken images obtained by taking the N pattern images sequentially projected. Specifically, the frequency analyzer 135 performs the discrete Fourier transform on the temporal change in the luminance at the coordinate (X, Y) in the taken image due to the sequential projection of the N pattern images. As a result, it is possible for the frequency analyzer 135 to calculate the phase values θ₁, θ₂, . . . , θᵣ. Specifically, a component corresponding to (the frequency) ±2n/N out of the value obtained by the discrete Fourier transform represents the phase value θ₁. Similarly, the component corresponding to (the frequency) ±4n/N represents the phase value θ₂. The component corresponding to (the frequency) ±2nr/N represents the phase value θᵣ.

In the phase shift method related to Document 1, one phase value can only be measured every time the phase shift method is performed once. In contrast, in the phase shift method according to the present embodiment, the pattern generator 131 generates the pattern image in which the amplitude of the projection pattern is determined using the formula obtained by adding the plurality of trigonometric functions different in temporal frequency. It is possible for the frequency analyzer 135 to calculate the plurality of phase values every time the phase shift method is performed once by performing the frequency analysis on the pattern image. In other words, the frequency analyzer 135 is capable of extracting a plurality of frequency components in a single execution of the phase shift method, and is therefore capable of calculating the plurality of phase values. As a result, it is possible for the pattern generator 131 to project, for example, a pattern image for a phase connection at the same time in addition to the regular pattern image. It should be noted that a definition of the “phase connection” will be described later. Further, the frequency analyzer 135 is capable of measuring the coordinate values in both of, for example, the x direction and the y direction at the same time. As a result, it is possible for the frequency analyzer 135 to dramatically reduce the execution time for executing the phase shift method, and the calculation time by the frequency analyzer 135.

The correspondence relationship generator 136 generates the correspondence relationship between the coordinate (X, Y) in the camera coordinate system in the taken image and the coordinate (x, y) in the panel coordinate system based on the coordinate (X, Y) in the taken image and the plurality of phase values calculated by the frequency analyzer 135. As described above, with respect to the coordinate (x, y) on the panel coordinate system, the plurality of phase values changing continuously is determined as the functions of (x, y) such as θ₁=g₁ (x, y), θ₂=g₂ (x, y), . . . , θᵣ=gᵣ (x, y). Therefore, it is possible for the correspondence relationship generator 136 to calculate the coordinate (x, y) in the panel coordinate system based on the plurality of phase values θ₁, θ₂, . . . , θᵣ. Further, as described above, the plurality of phase values θ₁, θ₂, . . . , θᵣ is calculated by performing the discrete Fourier transform on the temporal change in the luminance at the coordinate (X, Y) in the camera coordinate system. Therefore, it is possible for the correspondence relationship generator 136 to generate the correspondence relationship between the coordinate (X, Y) in the camera coordinate system and the coordinate (x, y) in the panel coordinate system. The x direction in the panel coordinate system is an example of a “first axis.” The y direction in the panel coordinate system is an example of a “second axis.”

The measurement value calculator 137 calculates a variety of measurement values using the taken images obtained by the first acquirer 134 and the correspondence relationship between the camera coordinate system and the panel coordinate system generated by the correspondence relationship generator 136. The “taken image” mentioned here is not limited to the pattern image described above, but includes the taken image generated by the imaging device 12 taking the projection surface in, for example, a geometric correction, a color correction of the projection image, and a normal usage of the projector 10. Further, the “measurement value” mentioned here can be one or more of, for example, a three-dimensional shape of the projection surface, a parallax between the projection lens provided to the projection device 11 and the imaging device 12, and color unevenness on the liquid crystal panel.

The correction value calculator 138 calculates a variety of correction values based on the measurement values calculated by the measurement value calculator 137. The correction values are used in, for example, the geometric correction described above or the correction of the color unevenness of the projection image.

The second acquirer 139 obtains an image, which the user of the projector 10 views in the normal usage, from an external device via the communication device 15. The external device is constituted by an output device of a variety of images such as a personal computer, a tablet, or a DVD (Digital Versatile Disc) player.

The image corrector 140 sets the variety of correction values calculated by the correction value calculator 138 to the correction circuits to thereby correct the image obtained by the second acquirer 139. Further, the image corrector 140 outputs the corrected image to the projection controller 132. The projection controller 132 makes the projection device 11 project the image obtained from the image corrector 140 in the normal use.

### 1-2: Operation of Embodiment

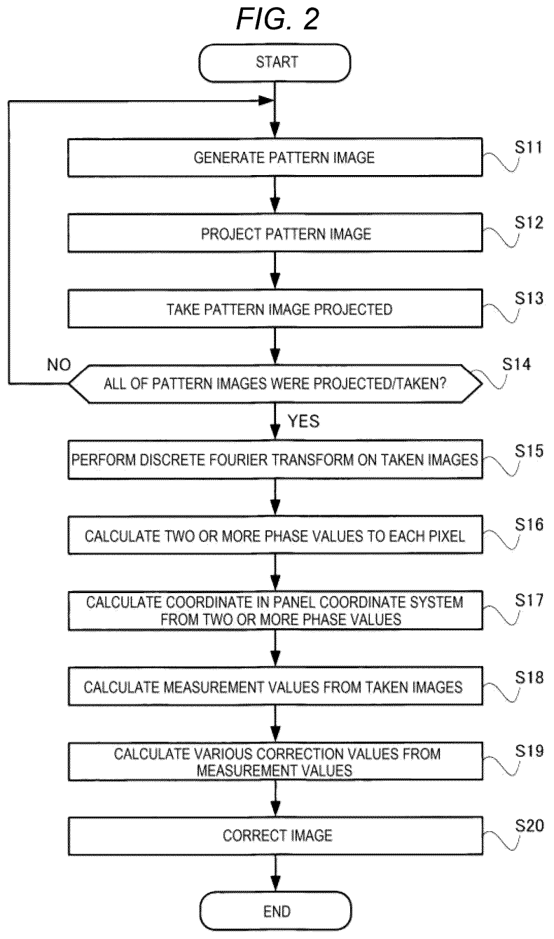

FIG. 2 is a flowchart showing the operation of the projector 10. The operation of the projector 10 will hereinafter be described with reference to FIG. 2.

In the step S11, the processing device 13 functions as the pattern generator 131. The processing device 13 generates a pattern image to be used in the phase shift method.

In the step S12, the processing device 13 functions as the projection controller 132. The processing device 13 makes the projection device 11 project the pattern image generated in the step S11 on the projection surface.

In the step S13, the processing device 13 functions as the imaging controller 133. The processing device 13 makes the imaging device 12 take the pattern image projected by the projection device 11 on the projection surface. Further, the processing device 13 functions as the first acquirer 134. The processing device 13 obtains the taken image, which is obtained by taking the pattern image, from the imaging device 12.

In the step S14, when the processing device 13 projects all of the pattern images and takes all of the pattern images (YES in S14), the processing device 13 executes the processing in the step S15. In the step S14, when the processing device 13 has not yet projected all of the pattern images and has not finished to take all of the pattern images (NO in S14), the processing device 13 executes the processing in the step S11.

In the step S15, the processing device 13 functions as the frequency analyzer 135. The processing device 13 performs the discrete Fourier transform in the time direction on the data representing the taken image obtained by the first acquirer 134.

In the step S16, the processing device 13 functions as the frequency analyzer 135. The processing device 13 calculates the phase values θ₁, θ₂, . . . , θᵣ corresponding to each pixel at the coordinate (X, Y) in the camera coordinate system based on the result of the discrete Fourier transform in the step S15.

In the step S17, the processing device 13 functions as the correspondence relationship generator 136. The processing device 13 calculates the coordinate values (x, y) in the panel coordinate system from the plurality of phase values θ₁, θ₂, . . . , θᵣ calculated in the step S16. Further, the processing device 13 generates the correspondence relationship between the coordinate values (X, Y) in the camera coordinate system and the coordinate values (x, y) in the panel coordinate system.

In the step S18, the processing device 13 functions as the measurement value calculator 137. The processing device 13 calculates the variety of measurement values using the taken images obtained by the first acquirer 134, and the correspondence relationship generated in the step S17.

In the step S19, the processing device 13 functions as the correction value calculator 138. The processing device 13 calculates the variety of correction values based on the measurement values calculated in the step S18.

In the step S20, the processing device 13 functions as the image corrector 140. The processing device 13 sets the variety of correction values calculated in the step S19 to the correction circuits to thereby correct the image obtained from the external device.

### 1-3: Practical Example

A specific practical example in which the processing device 13 generates the correspondence relationship between the camera coordinate and the panel coordinate, and performs the geometric correction or the color correction of the projector 10 using the correspondence relationship thus generated will hereinafter be described.

First, the pattern generator 131 generates the pattern image. When generating the pattern image, the pattern generator 131 sets four phase values corresponding to the coordinate (x, y) in the panel coordinate system using a function defined by Formula (2) through Formula (5) described below.

θ₁=2nx/T Formula (2)

θ₂=2ny/S Formula (3)

θ₃2nx/W Formula (4)

θ₄=2ny/H Formula (5)

It should be noted that in Formula (2) through Formula (5) described above, T denotes a period in the x direction corresponding to the standard phase shift method. S denotes a period in the y direction corresponding to the standard phase shift method. W denotes horizontal resolution of the liquid crystal panel. H denotes vertical resolution of the liquid crystal panel.

Here, θ₁ and θ₂ denote the same phase values as the phase values used in the standard phase shift method. In order to increase a detection accuracy of the phase shift method, the shorter the period T and the period S are, the better. However, due to the periodicity of the trigonometric function, when shortening the period T and the period S, there occur areas having the same phase value in a plurality of coordinates in the panel coordinate system. In order to make the phase values different from each other correspond one-to-one to the coordinates different from each other, the pattern generator 131 in the present practical example uses the phase value θ₃ defined by Formula (4) using the horizontal resolution W corresponding to the whole length in the x direction of the liquid crystal panel together with the phase values θ₁ and θ₂ instead of the period T in Formula (2). Further, the pattern generator 131 further uses the phase value θ₄ defined by Formula (5) using the vertical resolution H corresponding to the whole length in the y direction of the liquid crystal panel in addition thereto instead of the period S in Formula (3). It should be noted that using the phase values θ₃ and θ₄ corresponding to periods longer than those of the phase values θ₁ and θ₂ in addition to the phase values θ₁ and θ₂ is referred to as the “phase connection” in the present specification. By the pattern generator 131 using the phase values θ₃ and θ₄ in addition to the phase values θ₁ and θ₂, the phase values different from each other correspond one-to-one to the coordinates different from each other in the panel coordinate system. Formula (2) is an example of a “first luminance distribution,” Formula (3) is an example of a “second luminance distribution,” Formula (4) is an example of a “third luminance distribution,” and Formula (5) is an example of a “fourth luminance distribution.” The period T is an example of a “first period,” the period S is an example of a “second period,” the horizontal resolution W is an example of a “third period,” and the vertical resolution H is an example of a “fourth period.”

Since the number of the types of the phase values is r=4, the shift count N in the phase shift method to be executed in the present practical example, namely the number of the pattern images thus taken, is set no smaller than N=2r+1=9. The amplitude of the projection pattern at the coordinate (x, y) on the panel coordinate system is determined by Formula (6) described below with respect to pattern numbers n=0, 1, . . . , N−1.

f (x, y, n)=cos (θ₁2nn/N)+cos (θ₂+4nn/N)+cos (θ₃+6nn/N)+cos (θ₄+8nn/N) Formula (6)

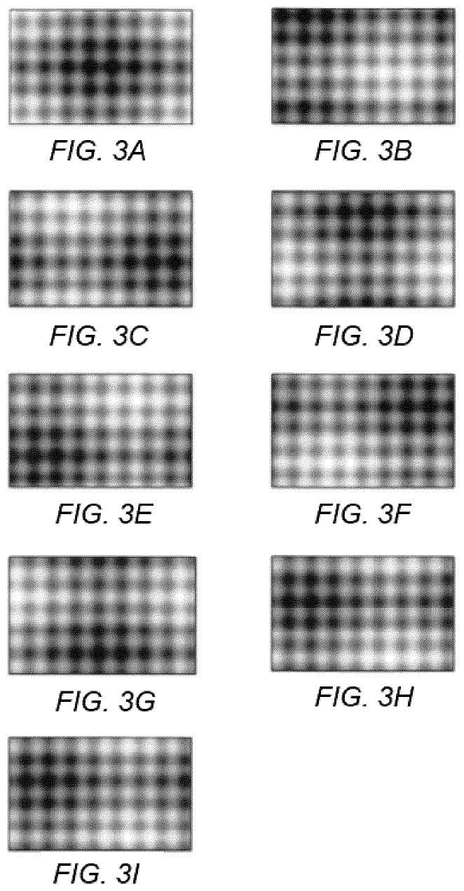

The projection device 11 sequentially projects the N pattern images having the projection pattern determined by Formula (6) described above. The imaging device 12 takes the N pattern images sequentially projected. It should be noted that FIG. 3A through FIG. 3I are an example of the N=9 pattern images. FIG. 3A is an example of a pattern image with n=0. FIG. 3B is an example of a pattern image with n=1. FIG. 3C is an example of a pattern image with n=2. FIG. 3D is an example of a pattern image with n=3. FIG. 3E is an example of a pattern image with n=4. FIG. 3F is an example of a pattern image with n=5. FIG. 3G is an example of a pattern image with n=6. FIG. 3H is an example of a pattern image with n=7. FIG. 3I is an example of a pattern image with n=8. In the example shown in FIG. 3A through FIG. 3I, W=8T and H=5S are set. However, W=8T and H=5S are illustrative only. The value W can be an arbitrary multiple of T, and the value H can be an arbitrary multiple of S. Further, the value W is not limited to an integral multiple of T, and the value H is not limited to an integral multiple of S.

The pattern images in the present practical example are each an image obtained by adding an image showing the first luminance distribution having the first period along the first axis, an image showing the second luminance distribution having the second period along the second axis perpendicular to the first axis, an image showing the third luminance distribution having a period longer than the first period along the first axis, and an image showing the fourth luminance distribution having a period longer than the second period along the second axis to each other.

The frequency analyzer 135 performs the frequency analysis on the taken images of the N pattern images. The luminance values in the N taken images of the pixels located at the coordinate (X, Y) in the camera coordinate system in the taken images are defined as a₀, a₁, . . . , A_{N-1}, respectively. Since the luminance value of the taken image is proportional to the luminance value of an imaging subject, the luminance value aₙ in the n-th taken image is represented by Formula (7) described below.

$${a}_{n} ≅ λ \{ cos ( {θ}_{1} + \frac{2 π n}{N} ) + cos ( {θ}_{2} + \frac{4 π n}{N} ) + cos ( {θ}_{3} + \frac{6 π n}{N} ) + cos ( {θ}_{4} + \frac{8 π n}{N} ) \} + C \qquad Formula ( 7 )$$

Here, a constant λ and a constant C are constants representing a gain and an offset of the taken image, respectively. For example, the constant λ is determined by the reflectance of the projection surface.

The values obtained by the frequency analyzer 135 performing the discrete Fourier transform on these N values of aₙ are defined as b₀, b₁, . . . , b_{N-1}. The discrete Fourier transform is represented by Formula (8) and Formula (9).

$$( \begin{matrix}\begin{matrix}\begin{matrix}{b}_{0} \\ {b}_{1}\end{matrix} \\ ⋮\end{matrix} \\ {b}_{N - 1}\end{matrix} ) = \frac{1}{N} ( \begin{matrix}{m}_{11} & … & {m}_{1 N} \\ ⋮ & ⋱ & ⋮ \\ {m}_{N 1} & … & {m}_{NN}\end{matrix} ) ( \begin{matrix}\begin{matrix}\begin{matrix}{a}_{0} \\ {a}_{1}\end{matrix} \\ ⋮\end{matrix} \\ {a}_{N - 1}\end{matrix} ) \qquad Formula ( 8 )$$

$${m}_{kl} = {e}^{- \frac{2 π ( k - 1 ) ( l - 1 )}{N} i} \qquad Formula ( 9 )$$

Due to the nature of the Fourier transform, each of the values bₙ fulfills Formula (10) through Formula (15) described below. (It should be noted that when N=9 is true, b₅=b_{N-4} is true.)

$${b}_{0} = C \qquad Formula ( 10 )$$

$${b}_{1} = \overline{{b}_{N - 1}} = \frac{λ}{2} ( cos {θ}_{1} - i sin {θ}_{1} ) \qquad Formula ( 11 )$$

$${b}_{2} = \overline{{b}_{N - 2}} = \frac{λ}{2} ( cos {θ}_{2} - i sin {θ}_{2} ) \qquad Formula ( 12 )$$

$${b}_{3} = \overline{{b}_{N - 3}} = \frac{λ}{2} ( cos {θ}_{3} - i sin {θ}_{3} ) \qquad Formula ( 13 )$$

$${b}_{4} = \overline{{b}_{N - 4}} = \frac{λ}{2} ( cos {θ}_{4} - i sin {θ}_{4} ) \qquad Formula ( 14 )$$

$${b}_{5} = {b}_{6} = … = {b}_{N - 5} = 0 \qquad Formula ( 15 )$$

Therefore, the phase values θ₁, θ₂, θ₃, and θ₄ with respect to each of the frequencies are obtained based on the values b₁, b₂, b₃, and b₄ on which the Fourier transform has been performed. Further, the x coordinate on the panel coordinate system corresponding to the pixel at the coordinate (X, Y) on the camera coordinate system is calculated from Formula (2) and Formula (4) described above. Similarly, the y coordinate on the panel coordinate system corresponding to the pixel at the coordinate (X, Y) on the camera coordinate system is calculated from Formula (3) and Formula (5) described above.

As an example, a specific example of the calculation value will hereinafter be described. The horizontal resolution of the liquid crystal panel is set to W=1920, and the vertical resolution thereof is set to H=1200. Further, the period in the x direction corresponding to the standard phase shift method is set to T=1920/8=240, and the period in the y direction is set to S=1200/5=240. It is assumed that the shift count, namely the number of the pattern images thus taken, is set to N=9, the projection device 11 sequentially projects the nine pattern images illustrated in FIG. 3A through FIG. 3I, and the imaging device 12 sequentially takes these projection images.

It is assumed that the pixel values a₀, a₁, . . . , a₈ of the nine taken images at the coordinate (X, Y) on the camera coordinate system have become the values shown below, respectively. These values are values obtained by imaging a change in luminance value at the position of the coordinate (x, y)=(633, 490) on the panel coordinate system with the imaging device 12.

a₀=140, a₁=211, a₂=189, a₃=179, a₄=264, a₅=219, a₆=152, a₇=109, a₈=224

The values b₁, b₂, b₃, and b₄ obtained when performing the discrete Fourier transform on these values become the following values.

b₁≅−10.488338 . . . +12.133552 . . . i

b₂≅15.556446 . . . −4.194335 . . . i

b₃≅−15.222222 . . . −4.618802 . . . i

b₄≅−13.568108 . . . −8.533659 . . . i

In each of the values bi, the real part is a value obtained by multiplying cosθ₁ by a constant, and the imaginary part is a value obtained by multiplying −sinθ₁ by a constant, and therefore, by using an inverse trigonometric function, the phase values θ₁, θ₂, θ₃, and θ₄ become the following values.

θ₁=3.999589 . . . [rad]

θ₂=0.263357 . . . [rad]

θ₃=2.846996 . . . [rad]

θ₄=2.580158 . . . [rad]

By inversely calculating the original x coordinate and the original y coordinate from the phase values θ₁, θ₂, θ₃, and θ₄, the values x₁, y₂, x₃, and y₄ become the following values.

x₁=152.773070 . . . +T×k

y₂=10.059534 . . . +S×1

x₃=869.978096 . . .

y₄=492.773891 . . .

In the values x₁, y₂, there exists indefiniteness of an integral multiple of +T, +S, respectively. In other words, the values x₁, y₂ are not uniquely determined. The indefiniteness is caused by the periodicity of the projection pattern. In contrast, the values of x₃ and y₄ are uniquely determined since the period of the projection pattern coincides with the resolution of the liquid crystal panel. It should be noted that since the change in the spatial direction of the phase is gentle, the values of x₃ and y₄ are easily affected by a noise, and are large in error. In reality, (x₃, y₄) is shifted no smaller than one pixel from a true value (873, 490). Therefore, x₃, y₄ are used for the phase connection for resolving the indefiniteness in x₁, y₂.

The values x₃=869.978096 . . . and y₄=492.773891 . . . are respectively within the following ranges, and therefore, the values x₁ and y₂ must be within these ranges.

T×3≤x₃≤T×4

S×2≤y₄≤S×3

Therefore, the following is obtained.

x₁=152.773070 . . . +T×3=872.773070 . . .

y₂=10.059534 . . . +S×2=490.059534 . . .

In the value (x₁, y₂), the error with respect to the true value (873, 490) falls within one pixel, and therefore, it is understood that the coordinate (x, y) on the panel coordinate system can accurately be measured.

Due to the above calculation, it is possible for the correspondence relationship generator 136 to obtain the correspondence relationship of the coordinate (x, y) on the panel coordinate system to the coordinate (X, Y) on the camera coordinate system.

After the correspondence relationship between the camera coordinate system and the panel coordinate system is generated, it is possible for the image corrector 140 to perform the geometric correction by, for example, performing the three-dimensional measurement on the projection surface based on the parallax between the projection lens provided to the projection device 11 and the imaging device 12, and applying a technology related to a stereo camera. Alternatively, it is possible for the image corrector 140 to measure the color unevenness on the liquid crystal panel to perform the color correction. It is possible for the image corrector 140 to perform a variety of corrections including the geometric correction and the color correction described above.

### 2: Modified Examples

The present disclosure is not limited to the embodiment hereinabove illustrated. Specific aspects of modifications will hereinafter be illustrated.

### 2-1: Modified Example 1

In the embodiment described above, the pattern generator 131 generates the N pattern images in which the amplitude of the projection pattern is determined by Formula (1). However, it is possible for the pattern generator 131 to generate a moving image as the pattern image represented by a formula obtained by generalizing Formula (1).

Specifically, the plurality of phase values is defined as θ₁, θ₂, . . . , θᵣ. Further, the temporal frequencies corresponding to the respective phase values are defined as ω₁, ω₂, . . . , ωᵣ. When the elapsed time from when starting the projection of the pattern image is defined as t, the amplitude of the projection pattern is represented by Formula (16) described below.

f(θ₁, θ₂, . . . , θᵣ, t)=A₁cos (θ₁+2nω₁t)+A₂cos (θ₂+2nω₂t) +. . . +Aᵣcos (θᵣ+2nωᵣt) Formula (16)

The imaging device 12 intermittently takes the moving image of the pattern image represented by Formula (16) and projected by the projection device 11 at arbitrary intervals.

It is possible for the frequency analyzer 135 to calculate the phase values θ₁, θ₂, . . . , θᵣ corresponding to the respective frequencies ω₁, ω₂, . . . , ωᵣ by performing the frequency analysis such as the Fourier transform on the luminance change in each of the pixels in the taken image.

It should be noted that when each of the frequencies ω₁, ω₂, . . . , ωᵣ is an integral multiple of a certain frequency ω₀, it is possible for the frequency analyzer 135 to execute the method described above.

### 2-2: Modified Example 2

In the practical example described above, the pattern generator 131 combines the four phase values θ₁, θ₂, θ₃, and θ₄ with each other. In other words, the pattern generator 131 generates the pattern image in which the amplitude of the projection pattern is shown using the formula obtained by adding the trigonometric functions corresponding respectively to the four phase values θ₁, θ₂, θ₃, and θ₄ to each other. However, the combination of the phase values to be combined with each other can be different from the above.

For example, it is possible for the pattern generator 131 to combine the phase values θ₁, θ₂ to be used for the detection of the accurate coordinate value and the phase values θ₃, θ₄ for the phase connection separately from each other. When combining several types of trigonometric functions corresponding respectively to the phase values different from each other with each other, the contrast per trigonometric function lowers, and therefore, the detection of the coordinate value becomes easy to be affected by the noise. Therefore, by decreasing the number of phase values to be combined by the pattern generator 131, it is possible to achieve both of the securement of the accuracy in detecting the coordinate values and the reduction in working time by the frequency analyzer 135.

First, the amplitude of the projection pattern included in the fine pattern image for detecting the accurate x coordinate and the accurate y coordinate is represented by Formula (17) described below.

f(x, y, n)=cos (2nx/T+2nn/N)+cos (2ny/S+4nn/N) Formula (17)

The first term in the right side of Formula (17) is an example of an image showing the first luminance distribution, and the second term in the right side of Formula (17) is an example of an image showing the second luminance distribution.

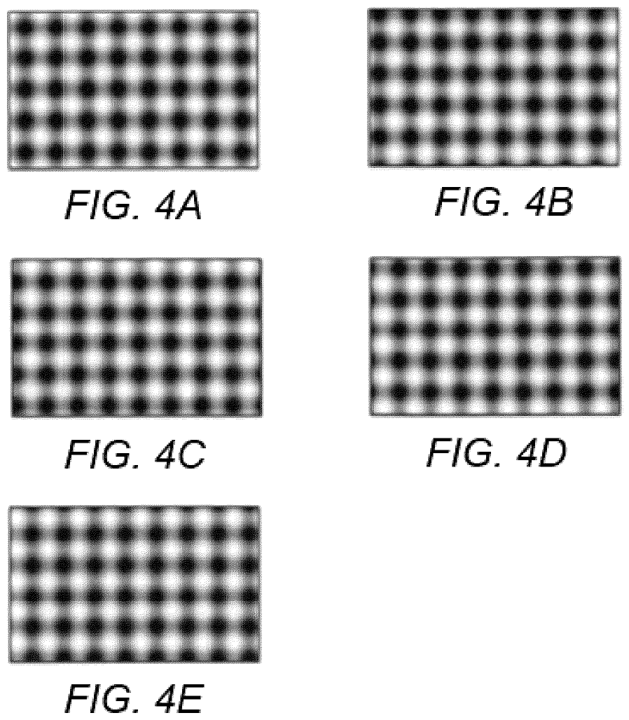

Since the number of the types of the phase values to be combined with each other is r=2, the number N of the pattern images to be taken is sufficiently no smaller than N=2r+1=5. It should be noted that FIG. 4A through FIG. 4E are an example of the N=5 pattern images corresponding to Formula (17). FIG. 4A is an example of a pattern image with n=0. FIG. 4B is an example of a pattern image with n=1. FIG. 4C is an example of a pattern image with n=2. FIG. 4D is an example of a pattern image with n=3. FIG. 4E is an example of a pattern image with n=4. The pattern image can be made based on Formula (17), or can also be made by adding an image which is made based on the first term in the right side of Formula (17) and an image which is made based on the second term in the right side of Formula (17) to each other.

The amplitude of the projection pattern included in a gentle pattern image for performing the connection of the phase is represented by Formula (18) described below.

f(x, y, n)=cos (2nx/W+2nn/N)+cos (2ny/H+4nn/N) Formula (18)

The first term in the right side of Formula (18) is an example of an image showing the third luminance distribution, and the second term in the right side of Formula (18) is an example of an image showing the fourth luminance distribution.

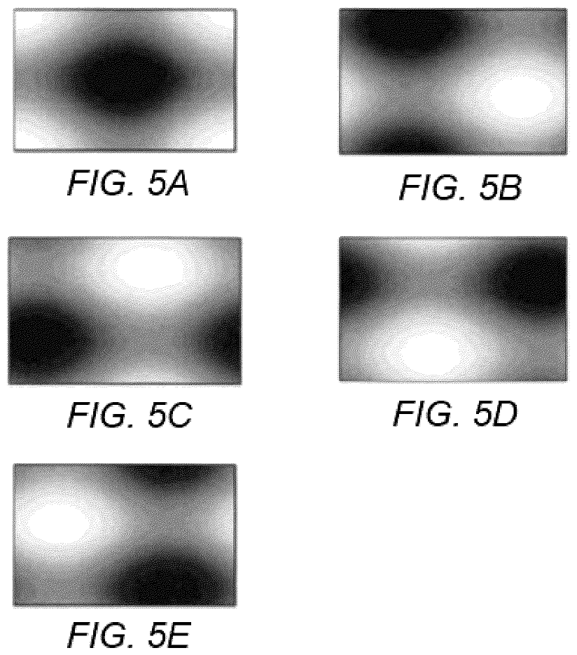

It should be noted that FIG. 5A through FIG. 5E are an example of the N=5 pattern images corresponding to Formula (18). FIG. 5A is an example of a pattern image with n=0. FIG. 5B is an example of a pattern image with n=1. FIG. 5C is an example of a pattern image with n=2. FIG. 5D is an example of a pattern image with n=3. FIG. 5E is an example of a pattern image with n=4. The pattern image can be made based on Formula (18), or can also be made by adding an image which is made based on the first term in the right side of Formula (18) and an image which is made based on the second term in the right side of Formula (18) to each other.

The first pattern image in Modified Example 2, namely the pattern image corresponding to Formula (17), is an image obtained by adding the image showing the first luminance distribution having the first period along the first axis, and the image showing the second luminance distribution having the second period along the second axis perpendicular to the first axis to each other. Further, the second pattern image in Modified Example 2, namely the pattern image corresponding to Formula (18), is an image obtained by adding the image showing the third luminance distribution having a period longer than the first period along the first axis, and the image showing the fourth luminance distribution having a period longer than the second period along the second axis to each other.

As described above, in Modified Example 2, by performing the phase shift method twice, it is possible for the frequency analyzer 135 to obtain the four phase values θ₁, θ₂, θ₃, and θ₄.

### 2-3: Modified Example 3

Alternatively, it is possible for the pattern generator 131 to combine the phase values related to the x direction with each other, and combine the phase values related to the y direction with each other. The amplitude of the projection pattern when combining the phase value for accurately measuring the x coordinate and the phase value for the phase connection with each other is represented by Formula (19) described below.

f(x, n)=cos (2nx/T+2nn/N)+cos (2nx/W+4nn/N) Formula (19)

The first term in the right side of Formula (19) is an example of an image showing the first luminance distribution, and the second term in the right side of Formula (19) is an example of an image showing the second luminance distribution.

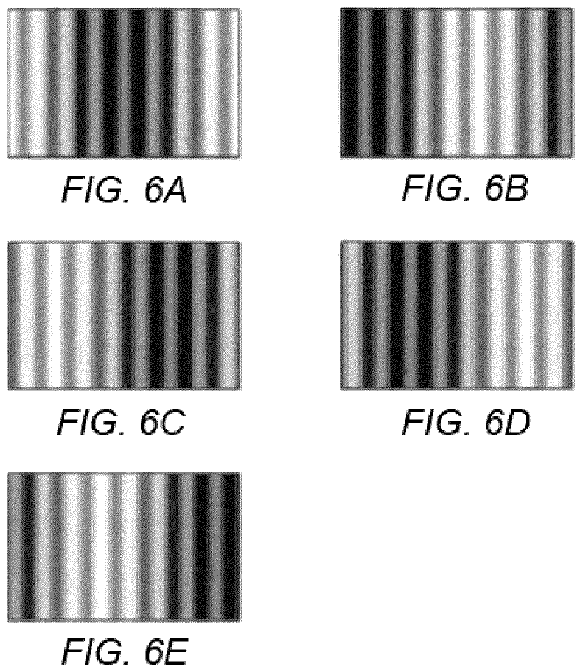

It should be noted that FIG. 6A through FIG. 6E are an example of the N=5 pattern images corresponding to Formula (19). FIG. 6A is an example of a pattern image with n=0. FIG. 6B is an example of a pattern image with n=1. FIG. 6C is an example of a pattern image with n=2. FIG. 6D is an example of a pattern image with n=3. FIG. 6E is an example of a pattern image with n=4. The pattern image can be made based on Formula (19), or can also be made by adding an image which is made based on the first term in the right side of Formula (19) and an image which is made based on the second term in the right side of Formula (19) to each other.

The same applies to the y direction.

The pattern image in Modified Example 3, namely the pattern image corresponding to Formula (19), is an image obtained by adding the image showing the first luminance distribution having the first period along the first axis, and the image showing the second luminance distribution having the period longer than the first period along the first axis to each other.

As described above, in Modified Example 3, it is possible for the frequency analyzer 135 to perform the accurate detection of the x coordinate and the connection of the phase at the same time. Similarly, in Modified Example 3, it is possible for the frequency analyzer 135 to perform the accurate detection of the y coordinate and the connection of the phase at the same time.

### 2-4: Modified Example 4

In the phase shift method, in general, by shortening the period in the spatial direction of the trigonometric function to increase the shift count, the accuracy is improved. Therefore, as an example, it is possible for the pattern generator 131 to combine the phase value short in period in addition to the phase value for accurately measuring the x coordinate and the phase value for the phase connection in order to detect the coordinate value higher in accuracy. Here, when assuming a period F as an arbitrary value shorter than the period T, the amplitude of the projection pattern is represented by Formula (20) described below.

f(x, n)=cos (2nx/F+2nn/N)+cos (2nx/T+4nn/N)+cos (2nx/W+6nn/N) Formula (20)

The first term in the right side of Formula (20) is an example of the third luminance distribution. The second term in the right side of Formula (20) is an example of the first luminance distribution. The third term in the right side of Formula (20) is an example of the second luminance distribution.

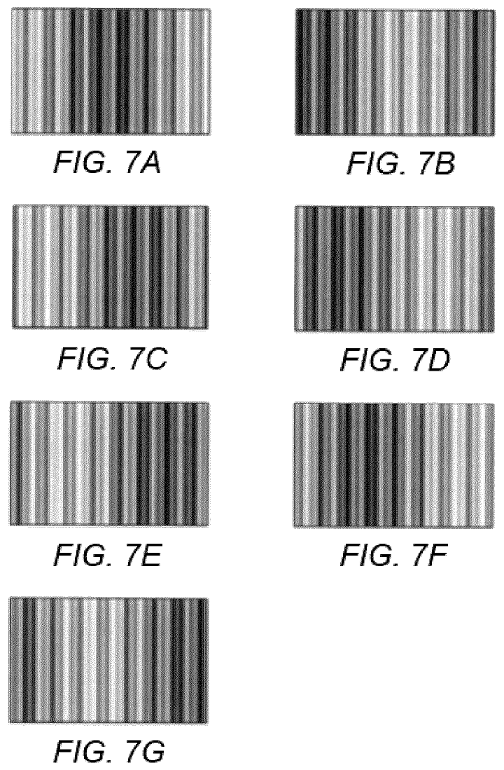

Since the number of the types of the phase values to be combined with each other is r=3, the number N of the pattern images to be taken is sufficiently no smaller than N=2r+1=7. It should be noted that FIG. 7A through FIG. 7G are an example of the N=7 pattern images corresponding to Formula (20). FIG. 7A is an example of a pattern image where n=0. FIG. 7B is an example of a pattern image with n=1. FIG. 7C is an example of a pattern image with n=2. FIG. 7D is an example of a pattern image with n=3. FIG. 7E is an example of a pattern image with n=4. FIG. 7F is an example of a pattern image with n=5. FIG. 7G is an example of a pattern image with n=6. The pattern image can be made based on Formula (20), or can also be made by adding an image which is made based on the first term in the right side of Formula (20), an image which is made based on the second term in the right side of Formula (20), and an image which is made based on the third term in the right side of Formula (20) to each other.

The same applies to the y direction.

The pattern image in Modified Example 4, namely the pattern image corresponding to Formula (20), is an image obtained by adding the image showing the first luminance distribution having the first period along the first axis, the image showing the second luminance distribution having the period longer than the first period along the first axis, and the image showing the third luminance distribution having the period shorter than the first period along the first axis to each other.

As described above, in Modified Example 4, it is possible for the frequency analyzer 135 to perform the more accurate detection of the x coordinate and the connection of the phase at the same time. Similarly, in Modified Example 4, it is possible for the frequency analyzer 135 to perform the more accurate detection of the y coordinate and the connection of the phase at the same time.

### 2-5: Modified Example 5

In the embodiment described above, the functions provided to the processing device 13 provided to the projector 10 can be realized by an external device of the projector 10. The external device is specifically a personal computer, a tablet, or the like. For example, it is possible to adopt a configuration in which the external device performs a function corresponding to the pattern generator 131 out of the functional blocks provided to the processing device 13, the pattern images generated by the external device are transmitted to the projector 10, and the projector 10 obtains the pattern images transmitted from the external device. Further, the functions provided to the processing device 13 provided to the projector 10 can be realized as applications which can be distributed via a communication network not shown. The external device is an example of a “computer.” Transmitting the pattern image generated by the external device to the projector 10 is an example of “outputting the pattern image.”

### 2-6: Modified Example 6

In the embodiment described above, the pattern generator 131 generates the pattern images, but it is possible for the processing device 13 to obtain the pattern images stored in the storage device 14 instead of being provided with the pattern generator 131.

### 2-7: Modified Example 7

In the embodiment described above, the projector 10 incorporates the imaging device 12, but the imaging device 12 can be an external device of the projector 10. The imaging device 12 as the external device of the projector 10 can be coupled to the projector 10 so as to be able to communicate with each other via an interface such as a USB interface.

### 3: Conclusion of Present Disclosure

Hereinafter, the conclusion of the present disclosure will supplementarily be noted.

### Supplementary Note 1

A method of outputting a pattern image including outputting a first pattern image which is used in a phase shift method, and which includes a first luminance distribution based on a first period, and a second luminance distribution based on a second period.

According to the method of outputting the pattern image described above, the first pattern image includes the first luminance distribution based on the first period and the second luminance distribution based on the second period. Therefore, when using patterns different in period from each other, it is possible for the projector to suppress the execution time for executing the phase shift method compared to the method of executing the phase shift method in each of the plurality of patterns. As a result, a convenience of the user is enhanced.

### Supplementary Note 2

The method of outputting the pattern image according to Supplementary Note 1, wherein the first luminance distribution has the first period along a first axis, the second luminance distribution has the second period along a second axis perpendicular to the first axis, and the first pattern image is an image obtained by adding an image showing the first luminance distribution and an image showing the second luminance distribution to each other.

According to the method of outputting the pattern image described above, it is possible for the projector to detect a coordinate value in a direction of the first axis and a coordinate value in a direction of the second axis with a single execution of the phase shift method by using the pattern image having the luminance distribution effective in each of the direction of the first axis and the direction of the second axis.

### Supplementary Note 3

The method of outputting the pattern image according to Supplementary Note 1 further including outputting a second pattern image obtained by adding an image showing a third luminance distribution having a period longer than the first period along a first axis, and an image showing a fourth luminance distribution having a period longer than the second period along a second axis perpendicular to the first axis to each other.

According to the method of outputting the pattern image described above, in the second pattern image, the image showing the third luminance distribution having the period longer than the first period along the first axis, and the image showing the fourth luminance distribution having the period longer than the second period along the second axis are added to each other. Therefore, it is possible for the projector to improve the detection accuracy of the coordinate value in the direction of the first axis and the coordinate value in the direction of the second axis with a single execution of the phase shift method.

### Supplementary Note 4

The method of outputting the pattern image according to Supplementary Note 1, wherein the first luminance distribution has the first period along a first axis, the second luminance distribution has a period longer than the first period along the first axis, and the first pattern image is an image obtained by adding an image showing the first luminance distribution and an image showing the second luminance distribution to each other.

According to the method of outputting the pattern image described above, the first luminance distribution has the first period along the first axis, and the second luminance distribution has the period longer than the first period similarly along the first axis. Therefore, it becomes possible for the projector to detect the accurate coordinate value by using the pattern image having the luminance distribution effective with respect to the single axis.

### Supplementary Note 5

The method of outputting the pattern image according to one of Supplementary Note 1 and Supplementary Note 4, wherein the first luminance distribution has the first period along a first axis, the second luminance distribution has a period longer than the first period along the first axis, and the first pattern image is an image obtained by adding an image showing the first luminance distribution, an image showing the second luminance distribution, and an image showing a third luminance distribution having a period shorter than the first period along the first axis to each other.

According to the method of outputting the pattern image described above, the first luminance distribution has the first period along the first axis, the second luminance distribution has the period longer than the first period similarly along the first axis, and the third luminance distribution has the period shorter than the first period similarly along the first axis. Therefore, it is possible for the projector to further improve the detection accuracy of the coordinate value in the single axis.

### Supplementary Note 6

The method of outputting the pattern image described in any one of Supplementary Note 1 through Supplementary Note 3, wherein the first luminance distribution has the first period along a first axis, the second luminance distribution has the second period along a second axis perpendicular to the first axis, and the first pattern image is an image obtained by adding an image showing the first luminance distribution, an image showing the second luminance distribution, an image showing a third luminance distribution having a period longer than the first period along the first axis, and an image showing a fourth luminance distribution having a period longer than the second period along the second axis to each other.

According to the method of outputting the pattern image described above, in the first pattern image, there are added the image showing the third luminance distribution having the period longer than the first period along the first axis and the image showing the fourth luminance distribution having the period longer than the second period along the second axis in addition to the image showing the first luminance distribution and the image showing the second luminance distribution. Therefore, it is possible for the projector to further improve the detection accuracy of the coordinate value in the direction of the first axis and the coordinate value in the direction of the second axis with a single execution of the phase shift method.

### Supplementary Note 7

The method of outputting the pattern image described in any one of Supplementary Note 1 through Supplementary Note 6 further including sequentially outputting 2r+1 pattern images including the first pattern image when assuming r as an integer no smaller than 2, wherein each of the 2r+1 pattern images has r luminance distributions, and in the r luminance distributions, luminance values at a same coordinate in at least one luminance distribution corresponding to a same period are different from each other.

According to the method of outputting the pattern image described above, the 2r+1 pattern images including the first pattern image are sequentially output. Further, the 2r+1 pattern images are different from each other in the luminance value at the same coordinate in at least one luminance distribution corresponding to the same period. Therefore, when using the pattern images different in phase from each other, it is possible for the projector to suppress the execution time for executing the phase shift method compared to the method of executing the phase shift method increasing the number of the patterns in order to raise the accuracy. As a result, a convenience of the user is enhanced.

### Supplementary Note 8

The method of outputting the pattern image according to any one of Supplementary Note 1 through Supplementary Note 7, wherein when defining two phase values with respect to a coordinate (x, y) on a panel as θ₁=g₁ (x, y), θ₂=g₂ (x, y), a number of times of performing a shift as N, and A₁ and A₂ as arbitrary constants, an amplitude f (x, y, n) of an n-th (n=0, . . . , N−1) projection pattern includes at least A₁cos (θ₁+2nn/N) as a term corresponding to the first luminance distribution, and A₂cos (θ₂+4nn/N) as a term corresponding to the second luminance distribution.

According to the method of outputting the pattern image described above, the amplitude f (x, y, n) of the projection pattern includes A₁ cos (θ₁+2nn/N) as the term corresponding to the first luminance distribution, and includes A₂cos (θ₂+4nn/N) as the term corresponding to the second luminance distribution. Here, θ₁=g₁ (x, y) is set, and θ₂=g₂ (x, y) is set. Therefore, it is possible for the projector to further improve the detection accuracy of the coordinate value in the direction of the first axis and the coordinate value in the direction of the second axis with a single execution of the phase shift method.

### Supplementary Note 9

A projector including an optical device, and at least one processor, wherein the at least one processor controls the optical device to thereby output a first pattern image which is used in a phase shift method, and which includes a first luminance distribution based on a first period, and a second luminance distribution based on a second period.

According to the projector described above, the first pattern image includes the first luminance distribution based on the first period and the second luminance distribution based on the second period. Therefore, when using the pattern images different in phase from each other, it is possible to suppress the execution time for executing the phase shift method compared to the method of executing the phase shift method increasing the number of the patterns in order to raise the accuracy. As a result, a convenience of the user is enhanced.

### Supplementary Note 10

A non-transitory computer-readable storage medium storing a program configured to make a computer execute processing including outputting a first pattern image which is used in a phase shift method, and which includes a first luminance distribution based on a first period, and a second luminance distribution based on a second period.

According to the program described above, the first pattern image includes the first luminance distribution based on the first period and the second luminance distribution based on the second period. Therefore, when using the pattern images different in phase from each other, it is possible for the projector to suppress the execution time for executing the phase shift method compared to the method of executing the phase shift method increasing the number of the patterns in order to raise the accuracy. As a result, a convenience of the user is enhanced.

What is claimed is:

1. A method of outputting a pattern image, the method comprising:
outputting a first pattern image which is used in a phase shift method, and which includes a first luminance distribution based on a first period, and a second luminance distribution based on a second period.

2. The method of outputting the pattern image according to claim 1, wherein
the first luminance distribution has the first period along a first axis,
the second luminance distribution has the second period along a second axis perpendicular to the first axis, and
the first pattern image is an image obtained by adding an image showing the first luminance distribution and an image showing the second luminance distribution to each other.

3. The method of outputting the pattern image according to claim 1, further comprising:
outputting a second pattern image obtained by adding an image showing a third luminance distribution having a period longer than the first period along a first axis, and an image showing a fourth luminance distribution having a period longer than the second period along a second axis perpendicular to the first axis to each other.

4. The method of outputting the pattern image according to claim 1, wherein
the first luminance distribution has the first period along a first axis,
the second luminance distribution has a period longer than the first period along the first axis, and
the first pattern image is an image obtained by adding an image showing the first luminance distribution and an image showing the second luminance distribution to each other.

5. The method of outputting the pattern image according to claim 1, wherein
the first luminance distribution has the first period along a first axis,
the second luminance distribution has a period longer than the first period along the first axis, and
the first pattern image is an image obtained by adding
an image showing the first luminance distribution,
an image showing the second luminance distribution, and
an image showing a third luminance distribution having a period shorter than the first period along the first axis to each other.

6. The method of outputting the pattern image according to claim 1, wherein
the first luminance distribution has the first period along a first axis,
the second luminance distribution has the second period along a second axis perpendicular to the first axis, and
the first pattern image is an image obtained by adding
an image showing the first luminance distribution,
an image showing the second luminance distribution,
an image showing a third luminance distribution having a period longer than the first period along the first axis, and
an image showing a fourth luminance distribution having a period longer than the second period along the second axis to each other.

7. The method of outputting the pattern image according to claim 1, further comprising:
sequentially outputting 2r+1 pattern images including the first pattern image when assuming r as an integer no smaller than 2, wherein
each of the 2r+1 pattern images has r luminance distributions, and
in the r luminance distributions, luminance values at a same coordinate in at least one luminance distribution corresponding to a same period are different from each other.

8. The method of outputting the pattern image according to claim 1, wherein
when defining two phase values with respect to a coordinate (x, y) on a panel as θ₁=g₁ (x, y), θ₂=g₂ (x, y), a number of times of performing a shift as N, and A₁ and A₂ as arbitrary constants, an amplitude f (x, y, n) of an n-th (n=0, . . . , N−1) projection pattern includes at least A₁cos (θ₁+2nn/N) as a term corresponding to the first luminance distribution, and A₂cos (θ₂+4nn/N) as a term corresponding to the second luminance distribution.

9. A projector comprising:
an optical device; and
at least one processor, wherein the at least one processor controls the optical device to thereby output a first pattern image which is used in a phase shift method, and which includes a first luminance distribution based on a first period, and a second luminance distribution based on a second period.

10. A non-transitory computer-readable storage medium storing a program configured to make a computer execute processing comprising:
outputting a first pattern image which is used in a phase shift method, and which includes a first luminance distribution based on a first period, and a second luminance distribution based on a second period.
